(19) United States
(12) Patent Application Publication
(10) Pub. No.: US 2009/0006341 A1
(43) Pub. Date: Jan. 1, 2009

(54) METHOD OF WEBSITE RANKING PROMOTION USING CREATION OF MASS BLOG POSTING LINKS

(76) Inventor: Bruce Chapman, Oceanside, CA (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/165,005

(22) Filed: Jun. 30, 2008

Related U.S. Application Data
(60) Provisional application No. 60/937,569, filed on Jun. 28, 2007.

(51) Int. Cl. G06F 17/30

(52) U.S. Cl. 707/3; 707/E17.014

(57) ABSTRACT

The present invention is directed to a method of promoting the high ranking of a website that is more certain to succeed and less susceptible to current and future advances in search engine filtering techniques. This method includes not only creating a large number of Major Specialty Areas each of which categorizes a general business area or activity to which a Blog is directed, but also further establishing a very large number of Sub-Specialty Areas within each Major Specialty Area so to more specifically categorize a business area or activity to which a Blog is directed. The method further includes determining the number of Blog Postings which need to be linked to a website to achieve a high ranking of the website by a search engine. For this purpose, the nature of the website is categorized, by the Blog Posting purchaser, into at least one Major Specialty Area and at least one Sub-Specialty Area within the Major Specialty Area. Next, Blog Distributor provides a requisite number of Blog Postings directed to the Major Specialty Area and Sub-Specialty Area needed to be linked to the website in order to achieve the high ranking. In this latter regard, the method includes determining how many Blogs are available from external Bloggers to provide the requisite number of Blog Postings. If the number of externally written Blogs is insufficient, then a number of Internal Blogs are created, this number of Blogs being sufficient to supply the remaining number of Blog Postings required. The result is that the requisite number and type of Blog Postings needed to be linked to the website in order to achieve the high ranking are provided, and this is done in a timely and cost efficient manner.

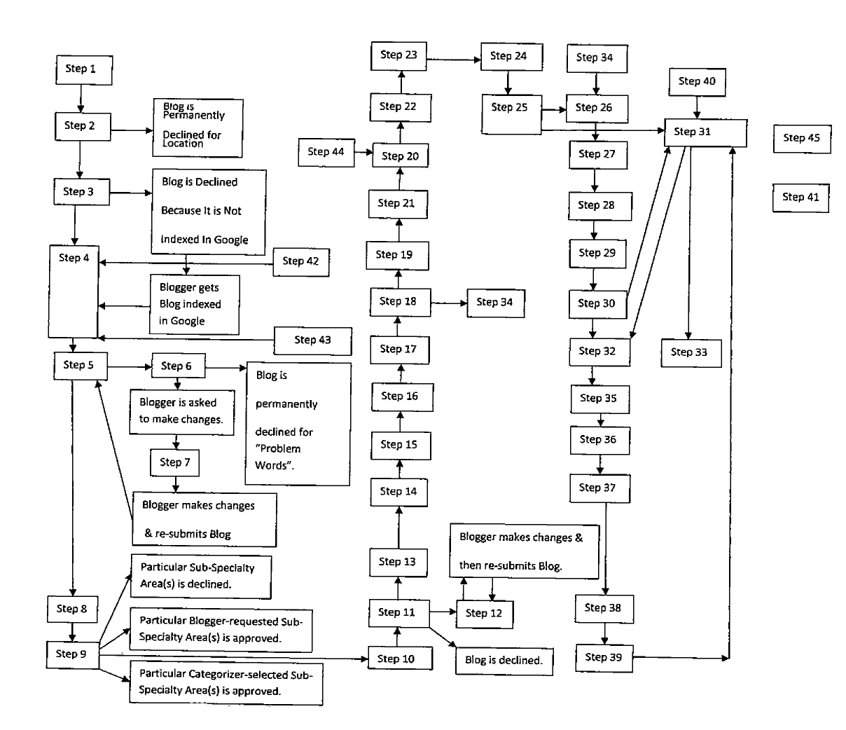

### CROSS-REFERENCE TO RELATED APPLICATIONS

This application claims priority to U.S. provisional patent application 60/937,569 filed Jun. 28, 2007, which is incorporated herein by reference.

### STATEMENT REGARDING FEDERALLY SPONSORED RESEARCH

Not Applicable.

### BACKGROUND OF THE INVENTION

This invention relates to website ranking promotion methods, and more specifically to a method for promotion of the ranking of websites on the major search engines through the use of blogs postings.

For purposes of this Specification, the following terms shall have the following meanings.

A “Blog” is a website that is an online journal and lists the most recent journal entries at the top of the website. Blogs can focus on a single or multiple areas of interest to a Blogger. The inventor's competitors only use 3^{rd} party Blogs. The inventor uses both 3^{rd} party Blogs and Internal Blogs.

A “Blog Post” or “Blog Posting” is an individual comment or entry in a Blog. A Blog Post, that is linked to a website, tends to increase the ranking of that website in Internet search engines such as Google® and Yahoo®.

A “Blogger” is a person who writes the Blog Postings for a Blog.

“Popularity” means how popular a Blog is on the Internet.

“Specialty Area” is a term created by the inventor to describe a category of subject(s) on which a Blog focuses. Another common term for Specialty Area is “Category”. Specialty Areas are divided into two levels. A “Major Specialty Level” refers to a major category of focus for a Blog. Examples of a Major Specialty Area include: “Arts”, “Beauty”, “Computers” and “Disabled”. A “Sub-Specialty Area” is a minor category of focus for a Blog that falls under a Major Specialty Area. Examples of Sub-Specialty Areas that would fit under the Major Specialty Area for “Arts” would include: “Animation”, “Books”, “Dance”, and “Movies”. As a further example, if a Blog focuses on selling cars in a retail dealership, then one of the Major Specialty Areas for that Blog would be “Shopping/Retail” and a Sub-Specialty Area would be “Cars”. An individual Blog can have a single Specialty Area, multiple Specialty Areas, or no Specialty Area. A Blog that has no Specialty Area is a Blog that comments on a variety of subjects but does not focus on any subject(s).

A “Blog Firm” is a company that puts together a group of non-employee, third-party Bloggers, purchases Blog Postings from them and sells those Blog Postings to Blog Posting buyers.

A “Reseller” is a firm that purchases Blog Postings from a Blog Firm and then sells those Blog Postings to its clients, who use the Blog Postings to improve the rankings of their individual websites. Resellers would include: search engine optimization (SEO) firms, website design firms, website hosting firms and ad agencies.

An “End-User” is a company that purchases Blog Postings to improve the rankings of their own individual website(s).

A “keyword” is a word that a website owner wants to get highly ranked in the major search engines for his website. For example, a website that focuses on cars might want to get the keyword “cars” highly ranked in the search engines.

Website log or “weblog” or “blog” are alternative nicknames for a form of website that generally contains a frequently updated textual journal with or without added media files but almost always with hyperlinks to other websites and blogs which the author of the website or blog thinks may be of interest to viewers of the blog. Various hyperlinks, graphic image files, video files, and other common files can be added to the blog as desired. If the blog is for a commercial purpose, a high ranking on major search engines becomes important so that the blog will be found and viewed frequently enough to make the effort in creating and maintaining the blog worth while. Time magazine has estimated that by 2020 there will be more than 100,000,000 blogs available for viewing on the Internet.

A website that is not highly ranked in major search engines such as provided by Google® or Yahoo®; e.g., in the top ten positions, has very little value because people rarely search beyond that point. About 75 percent of achieving high rankings for a website in these major search engines is based on the number and quality of incoming links to that website. There are two basic types of links, reciprocal links and one-way links. Reciprocal links are those links where two websites are linking to each other. Reciprocal links used to be helpful in achieving high rankings, but they are not very effective anymore because search engines have become more sophisticated in detecting them. Search engines do not like reciprocal links because they consider them to have only one purpose which is to artificially achieve high rankings for those two websites.

Until recently, one-way links came from these three sources:

a) link pages on a website, where the whole page is nothing but links;

b) link sections of a web page, where that whole section of the web page is nothing but links; and,

c) directories.

The problem is that these groupings of links are relatively easy to filter out because they do not look like normal information in a website. If a search engine's “spiders” (software that goes through a large number of websites searching for information to rank those websites) were changed to look for these groupings of links, they could easily give these a lower value or no value in the ranking process. The search engines can already filter out reciprocal links. This means that all of the links to a website can be partially or completely devalued, putting all of the search engine rankings for a website at risk.

The above described situation creates an opportunity to use an alternative type of link. Blog posts are ideal links if one is seeking a quantity of links that are highly valued by the major search engines. Blog posts are superior to standard links from a website because:
Search engines give their highest rankings to links that come from within the main text of a website. This is because these are the type of links that tend to genuinely show that the linked-from website “thinks” that the linked-to website is valuable.
It is very difficult to create any quantity of links from within the main text of a website. Website owners usually do not mind the minimal effort required to add someone's link to a link page, but putting a link from within the text of their website is a lot more work. It also has the risk that a visitor to the original website could leave that website and go to the linked-to website, thereby not purchasing anything at the original website. Therefore, the website owner is not going to do this very often. What is needed, therefore, is a solution that enables one to easily add as many links as their website needs, but links that are highly valued by the search engines.
A link from a link page or link section of a web page is not coming from within the text of the website; rather, it is just one in a long list of links. Blog posts have extensive text within themselves, so they do not look like a list of links. Since blog posts are generally all text and each blog post is viewed by the search engines as a whole website page, blog posts are given the same ranking value as a link from within the main text of a website, which equates to excellent rankings.
Each blog post has a title. The title may or may not include the keyword that is being promoted, but if the blog post is done correctly it can be related to the keyword. For example, the keyword inside a blog post might be “valentine flowers” and the title for the blog post is “online flowers”. Since each blog post is viewed by the search engines as a whole website page, the title of the blog post is seen by search engines as the page title (called the “title tag”). The major search engines all give a lot of ranking value to title tags. Normally, the title tag of a link page has nothing to do with the any particular keyword that one is trying to get highly ranked on the website being linked to. Therefore, blog posts normally have much better title tags than links on a link page and normally achieve higher rankings. They are simply more powerful for ranking purposes.

Blog posts are also considered superior to links from directories because a link from a directory is not coming from within the text of the website. Instead; it is just one in a long list of links (like a link page). In addition, search engines know that many directories sell their links, so the search engines know that these types of links are not really of the same quality as links from within the main text of a website and they therefore give the directory links a lower ranking value. Since blog posts are generally all text and each blog post is viewed by a search engine as a whole website page, blog posts are given the same ranking value as a link from within the main text of a website, which means an excellent ranking.

Currently, there are approximately 15 blog firms that order Blog Postings from bloggers to fit the needs of “End-Users” which are those firms that use Blog Postings to improve the rankings of their own websites. Blog firms also sell Blog Postings to “Resellers” which are those firms that buy Blog Postings and sell them to their clients. Resellers include SEO firms, website hosting firms, ad agencies and website design firms. In the blogging business, resellers operate as retailers to their clients.

Blog firms exist because an intermediary is necessary to ensure that:
Bloggers get paid for their blog posts; and
Quantities of blog posts get created by a large number of bloggers and that group of bloggers is pre-assembled by blog firms.

It is not unusual for the same blog to create Blog Postings for several Blog firms. Aside from the inventor's company, blog firms do not have their own internal bloggers.

A major problem in the blog firm business is that they are not set up to deal with large quantities of Blog Postings that are pre-categorized by all three of the following: Popularity, Specialty Area and Price.

Popularity is determined using Google's PageRank™ which is a bar graph that uses a scale of 0 to 10. The graph shows the number and quality of links coming into a particular website.

“Specialty Area” is a term created by the inventor to describe a category of the subject on which a blog focuses. The inventor has created two levels of Specialty Areas: “Major Specialty Areas” and “Sub-Specialty Areas”. A Major Specialty Area is a top level category of specialty areas; for example, “Distribution/Wholesale”, “Shopping/Retail”, “Home” or “Senior Adults”. Major Specialty Areas are not used to define the areas on which a blog focuses; rather, they are used to make it easier to find an appropriate Sub-Specialty Area for a blog. Examples of Sub-Specialty Areas under the Major Specialty Area of “Senior Adults” would include, for example, “Adult Day Care”, “Caregivers”, “Geriatrics”, etc. A single blog can have a single Sub-Specialty Area or multiple Sub-Specialty Areas or no Sub-Specialty Area. A blog having no Sub-Specialty Area is one that comments on a variety of subjects and does not focus on any particular one.

Price is how much an individual Blog Posting costs.

The Popularity, Specialty Area(s) and Price of a blog also apply to each individual Blog Posting within a Blog.

The inability to quickly and easily purchase quantities of Blog Postings works poorly when a blog firm is selling to End-Users, but the situation is even worse when the blog firm is selling to Resellers. End-users, who typically have just one website, are sometimes willing to spend the large amounts of time that it takes to filter out those blogs that specialize in their particular type of business, and to negotiate the pricing from a large number of blogs, one at a time, because it is so important for them to do these things in order to achieve high rankings for their website. However Resellers, who deal with large numbers of their clients' websites, simply cannot afford to invest the amount of time that it takes to go through this process, so they don't even try. What Resellers currently do, if they buy Blog Postings at all, is to buy them without any categorization. Although this is not nearly as effective in improving search engine rankings as using blogs that focus on the same types of businesses as that of their clients, it does work. However, it requires them to buy a much larger number of Blog Postings and deal with a much larger number of Blogs, which is an inefficient process. It also tends to take a lot longer to achieve high rankings, since the search engines award high search engine rankings more quickly to websites that have “relevant” Blog Postings linked to them. “Relevant” means that the blog focuses on the same subject that the website focuses on.

Although blog firms serve as intermediaries between bloggers and End-Users/Resellers, the blogs have not been sufficiently “pre-categorized” (categorized according to popularity, specialty area and price), so that it is easy to purchase a quantity of Blog Postings. Currently, in most situations, each blog sets its own price per Blog Posting. This means that there are literally millions of different prices for Blog Postings from millions of Blogs. For a given level of popularity and specialty area, the price per Blog Posting varies tremendously. Two blogs having the same level of popularity and specialty area could easily have a pricing relationship where one blog is priced at a high multiple of the price of the other blog. The End-Users/Resellers must therefore look at each individual Blog to decide if it meets their price criteria for the level of popularity and specialty area that they seek. It will be appreciated that it is very time-consuming to analyze each blog, one at a time, and this makes it extremely difficult for End-Users/Resellers to quickly make purchases of quantities of Blog Postings. Some blog firms sell Blog Postings for a set price, but when they do, there is no categorization by popularity or specialty area, which makes them less effective in achieving high search engine rankings.

Blog Distributor's solution is to create an 11-level pricing structure based on the popularity of the Blog and then the Blog buyer has only one more choice; i.e., to choose a Sub-Specialty Area or not. This simplified pricing approach can literally save a Blog Posting buyer thousands of hours in analyzing the pricing of large numbers of Blogs. A normal order can be made in our System in under an hour. Using our competitors' current systems, even when a relatively small number of websites need Blog Postings, it is still necessary to manually look through thousands of Blogs in order to find reasonable pricing for Blog Postings.

The following is an explanation of the manual process a Blog buyer must go through to compare the pricing of Blogs:

a) The only way to find out how much an individual Blog charges for a Blog Posting is to send an e-mail to them asking for their pricing. Blogs do not normally respond to phone calls. The average Blog does not maintain a pricing page on their Blog. Many Bloggers are not very good at returning these e-mails so it can take a long time to find out the pricing from a number of Blogs.

b) Once the Blog buyer has figured out the Blog Posting pricing from each of hundreds of Blogs, he must also check the Google® PageRank™ of each Blog, one-at-a-time to find out how popular each Blog is. If the Blog buyer does not do this step, he could easily over-pay for a Blog that is not that popular in the search engines.

c) Then he must create a spreadsheet that compares the pricing vs. the Google® PageRank™ for hundreds of Blogs.

d) Then the Blog buyer must analyze this information to find the best values.

e) Only when the Blog buyer has gone through all of these steps can he decide which Blogs he wants to buy from.

In our competitors' systems, the Bloggers categorize themselves. Most Blog Firms, if their Blogs are categorized by Specialty Area at all, use very general categories, such as “Government”, “Education”, “Business” and “Entertainment”. They generally have between 24 and 36 Specialty Areas. As discussed hereinafter, Blog Distributor has over 7,000 Specialty Areas. For example, they may use the Specialty Area of “business”, but there is no further breakdown of business into “retail”, “manufacturing” or “wholesale”, let alone “car business” vs. “appliance business” vs. “shoe business”. If you are an End-User and your business is shoes, a Blog Post from a Blog that specializes in the car business will not get you nearly as good a ranking in the search engines as a Blog Posting from a Blog that specializes in the shoe business. The search engines reward links between websites that have natural relationships. The shoe business and the car business do not such a natural relationship. While the inventor and his competitors may be dealing with the same Blogs, because the competitors use such general categorizations of their Blogs, their Blog Postings are not as valuable as those of the inventor because of the use of a more detailed level of categorization.

Only one blog firm, ReviewMe, (found at www.reviewme.com) categorizes Blogs down to the business-type level, but their approach is inadequate for the purposes of achieving high website rankings. This is because they do not offer a detailed list of categories for a blogger to choose from, to describe their own blog and because bloggers are terrible at categorizing their own blogs. Instead, the blogger can use any terminology they choose to describe their own blog. There are two problems with this approach.

a) If the blogger, for example, describes his blog as focusing on “Doctors” and a blog buyer is looking for a blog that focuses on “Physicians”, they will never find each other. This is because the matching process is contained in a database, and databases do not understand “similar” words. To find a match in a database, the category language that the blogger uses and the blog buyer uses, must both be exactly the same. Otherwise, although both of them are using the same blog firm's system, they will never find each other. And since ReviewMe does not enforce a common language of categories, this problem happens commonly.

b) Bloggers are writers. Writers are creative-types, not analytical-types. Since the inventor's staff have manually categorized 3^{rd} party blogs, after the bloggers have categorized their blogs, with both of us using our 7,000 “Sub-Specialty Area” (business-type category) list in accordance with the invention as described hereinafter, his staff knows that the bloggers are terrible at categorizing their own blogs. His staff have found that bloggers mis-categorize their blogs about 70% of the time. This is important because Blog Posting buyers are willing to pay a premium price for blogs that focus on the same types of businesses as their clients' websites focus on. If blogs are mis-categorized, then the blog buyers will not get the search engine ranking that they expect because the Blog Postings will not be “relevant” to the websites to which they are linked. Blog buyers are very willing to pay a premium price for “relevant” Blog Postings, but they will not pay that premium for Blog Postings that are supposed to be relevant, but are not.

Further, ReviewMe is quite limited in the number of Blog Postings it can provide in a specific category. For example, when a search in ReviewMe's system was done some months ago for the term “shoe”, they could provide only four Blogs. The average website typically needs at least 100 blog firms to get enough Blog Posting links to achieve high rankings in search engines. In the above example, they were ninety-six firms short of meeting the needs of a website in the shoe business. This means that ReviewMe has failed to achieve the goal of high search engine rankings for that client, using relevant Blog Postings.

Since all blog firms work with the same large group of blogs, and the blogs are all independent contractors, this shortfall in the number of blogs that focus on a particular specialty area is common to all of them. This means that all blog firms have the same problem. There simply are not enough blogs that focus on individual types of businesses to enable any of the blog firms to achieve high search engine rankings using relevant blogs. This is why Blog Distributor created the concept of internally owned blogs that are written by independent contractor writers. This enables the Blog Distributor to have an unlimited supply of blogs that are relevant for any website.

In order to categorize a Blog, our Categorizer reads through a number of Blog Postings on each Blog. This is quite time-consuming and expensive, but it does produce Blogs that are accurately categorized. For the Blog purchaser, the alternative is to manually look through thousands of Blogs one-at-a-time. The reason that the Blog purchaser has to look through so many Blogs is that he needs to find relevant Blogs to his clients' websites and the only way to filter out those Blogs is to read though a quantity of Blog Postings on each individual Blog. As previously discussed, this is extremely time-consuming and can literally take thousands of hours. Instead, the Blog purchaser can make an order for a large number of relevant Blogs from Blog Distributor in about an hour.

There is a need for a better way of promoting a website or blog that is more certain to succeed and less susceptible to current and future advances in search engine filtering techniques.

### BRIEF SUMMARY OF THE INVENTION

The present invention solves the above need for a better way of promoting the ranking of a website that is more certain to succeed and less susceptible to current and future advances in search engine filtering techniques. This includes not only creating a large number of Major Specialty Areas each of which categorizes a general business area or activity to which a blog is directed, but also further identifying a large number of Sub-Specialty Areas within each Major Specialty Area so to categorize more specifically a business area or activity on which a blog is focused. The method further includes determining the number of Blog Postings which need to be linked to a website to achieve a high ranking of the website by a search engine. For this purpose, the nature of the website is categorized by the purchaser of the Blog Postings into at least one Major Specialty Area and at least one Sub-Specialty Area within the Major Specialty Area. This facilitates the requisite number of Blog Posting focused on the Major Specialty Area and Sub-Specialty Area to be provided to the purchaser for linking to the website for the website to achieve high rankings in the search engines.

In this latter regard, the method includes determining how many Blog Postings are available from external bloggers to provide the requisite number of Blog Postings. If the number of externally written blogs is insufficient, then a requisite number of Internal Blogs are created, this number of Blogs being sufficient to supply the remaining number of Blog Postings required. The result is that the requisite number and type of Blog Postings needed to be linked to the website in order to achieve high rankings are provided, and this is done in a timely and cost efficient manner.

Other objects and features will be part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawing which forms a part of the specification.

The sole FIGURE of the drawing is a flow chart illustrating the steps involved in performing the method of the invention.

### DESCRIPTION OF THE PREFERRED EMBODIMENT

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

As discussed in the Background section of this Specification, most Blog Firms, if they categorize their Blogs by Specialty Area at all, use very general categories. They generally have only between 24 and 36 Specialty Areas; whereas Blog Distributor has over 7,000 Specialty Areas. For example, they may use the Specialty Area of “business”, but there is no further breakdown of business into “retail”, “manufacturing” or “wholesale”, let alone “car business” vs. “appliance business” vs. “shoe business”. If you are an End-User and your business is shoes, a Blog Post from a Blog that specializes in the car business will not get you nearly as good a ranking in the search engines as a Blog Posting from a Blog that specializes in the shoe business. The search engines reward links between websites that have natural relationships with higher rankings. The shoe business and the car business do not such a natural relationship. While the inventor and his competitors may be dealing with the same Blogs, because the competitors use such general categorizations of their Blogs, their Blog Postings are not as valuable as those of the inventor because of the use of a more detailed level of categorization.

The method of categorization used with the method of the present invention is superior to that used in search engines because a “context” is provided which search engines do not provide. For example, if one types the word “car” in a search engine, the search engine will direct the person to websites that focus on all of the following, without differentiation: retailers, distributors, manufacturers, and end users of cars. Accordingly, the results of the search include a lot of inappropriate websites that waste the time of the searcher as they filter through them, one at a time, to locate what they are seeking. The real problem this exemplifies is that a search engine's approach includes no ability to search within a particular context, so the searcher winds up having to look through a lot of “junk”. Although other types of businesses, such as the telephone company, have categorized the different types of companies, this has not happened in the Blog business until Blog Distributor did it.

Even though there are industry-specific directories that sometimes enable one to find the level of categorization that is now offered, these types of directories are not used by the general public. They are only readily available to people who work in that particular type of business. Our system is meant to be used by everybody to find every type of business in the USA. No other firm has ever created a general directory that goes to that level of detail.

Our categorization of “Specialty Area” (subject(s) that the Blog focuses on) is hundreds of times as detailed as our competitors (approximately 7,000 Sub-Specialty Areas); so that, in essence, every type of business in the United States is being categorized.

Categorizing the Blog marketplace is different from the type of categorization that one finds in directories such as the Yellow Pages or the Internet. Some Blogs tend to focus on certain age groups of the market, such as “babies” or “seniors”, so we had to create categories for all of the products and services that people in particular age groups would tend to purchase. At present, there are seven of them. When I looked in the Yellow Pages for products that Senior might use, for example, there was nothing there.

Some Blogs concentrate on providing services for particular types of facilities or locations. So, we have a Major Specialty Area titled “Buildings/Locations—Repair, Upkeep, Inspection & Cleaning”. This Major Specialty Area is broken down into many Sub-Specialty Areas such as: “Adult Day Care Centers”, “Airport Terminals”, & “Biking Trails”. This type of categorization is done because it reflects real life. Obviously, a person who does repairs on a Biking Trail has different skills than a person who does repairs In an Adult Day Care Center. If one looks in the Yellow Pages for these types of services, there is no listing for them.

Other Blogs focus on providing services for particular types of products or equipment, so we have a Major Specialty Area named “Product/Equipment—Repair, Upkeep, Inspection & Cleaning”. This Major Specialty Area is broken down into Sub-Specialty Areas such as: “Antique & Classic Cars”, “Aquariums”, and “ATMs”. Obviously, anybody who does repairs on Antique Cars would be a different person than a person who does repairs on ATMs. If one looks in the Yellow Pages, one will not find any listing for any of these types of services.

Also, it is important to note that the store that sells aquariums is not necessarily the same firm that repairs aquariums, so having a Categorization system that differentiates between these two different types of businesses is useful when you are trying to accurately categorize every type of business in the United States.

Another area where our Categorization is superior to the other directories is in our breakdown of products into: “Shopping/Retail”, “Distribution/Wholesale” and “Manufacturing”. When one looks at the Yellow Pages, this degree of categorization is missing for most products. It is, however, very important. For example, a firm that manufactures a “broom” is very different from a firm that sells a “broom” in a retail store. If one is trying to accurately categorize products, it is important to differentiate between manufacturers, wholesalers and manufacturers. Our approach makes the Categorization system superior to the categorization systems used by other firms.

Search engines are relatively poor at finding what you are seeking. The result is that there is normally a lot of junk in the results that one gets in the search engines. In search engines a supplier of a product or service can call it anything he wants. A purchaser can search for that same product or service using any terminology he wants. This creates a problem because there are so many terms that could be used to describe the same product or service. For example, if the Blogger describes his Blog as focusing on “Doctors” and the Blog buyer is looking for a Blog that focuses on “Physicians”, they will never find each other. This is because the matching process is contained in a database and databases do not understand “similar” words. To find a match in a database, the category language that the Blogger uses and the Blog buyer uses, both must be exactly the same. Otherwise, although both of them are using the same search engine, they will never find each other. To solve this problem, we have created a common set of Categories that Bloggers use to describe the type of business that their Blog focuses on and the Resellers use to find Bloggers that focus on a particular type of business. This common language is critical to ensuring that Resellers can quickly and accurately order Blog Postings that match the needs of their Clients for relevant Blog Postings.

In our Categorization System, a single product could be in multiple Major Specialty Areas at the same time. For example, a “potato” could be under the Major Specialty Area of:

a) “Food & Beverages” for the person who is thinking of the potato as a food item, including how to cook it

b) “Farming” for the person who is thinking of the potato as a crop “Shopping/Retail” for the person who is thinking of the potato as a product that is bought in a store

c) “Wholesale/Distribution” for the person who is thinking of the potato as a product that is being wholesaled by a distributor

d) “Wholesale/Distribution” for the person who is thinking of the potato as a product that is being wholesaled by a distributor.

This enables a product to be searched for by different people who have very different perspectives on that same product. It also enables the searcher to connect with the Blog that has the same perspective on that product as the searcher.

The system of the present invention addresses this problem by providing two levels of categorization. The first level is Major Specialty Area which includes, for example, “Shopping/Retail”, “Distribution/Wholesale”, “Manufacturing”, and “End-User”. As such, the Major Specialty Area classification provides the context so that, for example, if a Blog Posting purchaser is looking for a Blog that focuses on “car retailers”, he does not end up with one that focuses on “car manufacturers”.

The second level of classification is the Sub-Specialty Area. This includes all of the sub-categories under each Major Specialty Area. For example, under the Major Specialty Area for “Shopping/Retail”, one would find “Cars”, “Telephones”, “Pens”, “Calculators”, etc. This level therefore enables the searcher to find exactly what they are looking for, within the appropriate context. Using this approach, if one is looking for a manufacturer of “Calculators”, they do not end up looking at websites for retailers of “Calculators”. As a result, this approach saves the researcher a substantial amount of time because they find only what they are looking for, and nothing else.

Having a very detailed level of categorization of Specialty Areas, does create a problem. For almost every type of business, there is a very limited number of Blogs that specialize in that business. Normally, for ranking purposes, you want one Blog Posting, from each Blog, to each End-User's website, per month. So, for example, one may want 50 Blog Postings per month going to a shoe business website. However, there may be only 10 Blogs that specialize in the shoe business. So, in the first month, a Blog Firm is 40 Blog Postings short for this End-User. For the next month, for ranking purposes, another 50 Blog Postings will be needed from 50 Blogs and these should be different from the Blogs that used in the first month. If one alternates Blogs every month, one will end up needing a total of 90 additional Blogs that specialize in the shoe business, but these do not exist. In accordance with the invention, the solution is to create those 90 Blogs, which are owned by a Blog Distributor, and to have a Blog Distributor's own third-party writers create the Blog Postings.

Further in order to achieve high rankings, one must have the right number of Blog Postings linked to a website. The method of the present invention automatically determines the number of Blog Postings that End-Users need and displays that number to the Blog Posting purchaser. Otherwise, Resellers and End-Users are forced to guess what number of Blog Postings their websites need. If they under-guess, their website will not get highly ranked in the search engines. If they over-guess, they will pay for Blog Postings that are unnecessary. Blog Distributor's competitors do not offer this information to their clients.

In accordance with the present invention, the System automatically checks for the number of websites that link to the top ten websites in Google®, for each keyword. Based on that number, the System automatically calculates the number of Blog Posting links that a Reseller will need to purchase in order to achieve high search engine rankings for that individual keyword. As a rule, individual keywords each require a different number of Blog Postings to achieve high rankings in the search engines.

Another problem is how to attract the best Bloggers? By categorizing Blogs at the business-type level, one can pay more for, and charge more for, Blogs that have Specialty Areas.

Categorization of Blogs by their area of specialization is critical to achieving high search engine rankings and it needs to be done down to the “business-type” level or else Resellers will not be able to use the smallest number of Blog Postings to achieve high search engine rankings. If this categorization is not done accurately, then Resellers will end up not trusting the firm from which the Blogs were purchased.

It is also important that the Reseller/End User be provided high quality Blogs. When Blog Postings are purchased from our competitors, there is currently no process for ensuring that they are professionally written, with the possible exception that some competitors may check for pornographic language. The average Blog is poorly written with problems in the following areas:

profanity,
pornographic/adult language
misspellings,
English/Grammar is poor,
promotes racial intolerance,
promotes illegal drug use,
hate-oriented language,
not all in English language,
not indexed in Google,
promotes illegal activity,
violent language,
there are not enough Blog Postings,
words are missing from sentences,
capitalization is incorrect,
punctuation is incorrect,
in order for clients to look at this Blog, they must set up an account and sign in,
Blogger is located outside of USA, Canada or their territories,
Blog is primarily audio or video in format,
Blog is actually a book in serial format or a series of articles about a fictional subject,
The content of this Blog is duplicated (at least partially) in another Blog or website,
We cannot get to all of the pages listed on this Blog,
We cannot get to this Blog,
This is not a Blog, it is just a bunch of links,
Blog is not professional looking.

Website owners do not like to have Blogs that have these problems linking to their websites. They feel that it hurts their websites' reputations. With our competitors, the only solution to this problem is for the Blog Posting purchaser to manually go through large numbers of Blogs and read many Blog Postings on each Blog, one-at-a-time, to see if it has any of these problems. Once he has done this, he now needs to write e-mails to each individual Blog and ask the Blogger to fix the specific problems in that Blog. To send off this e-mail, the retailer has to keep track of which problems each Blog has, get the e-mail address for each Blog, write the e-mail and mail the e-mail. Then he has to read through the Blog multiple times to see if the problems have been fixed. For a retailer of Blog Postings, this can literally take thousands of hours. It is unlikely that the Blogger is going to fix the problems anyway because the retailer simply does not purchase enough Blog Postings from any single Blog to make it worthwhile for the Blogger to fix the problems, so the repair to the Blog is probably not going to happen anyway.

On the other hand, if the retailer of Blog Postings deals with Blog Distributor, all of these problems are taken care of by Blog Distributor. Our System automatically checks the Blogs for nine “Word Problem's. Then our Categorizer checks each Blog for an additional 15 problems, for a total of 24 problem checks. If the Categorizer finds any problems, he sends an e-mail to the Blogger, asking him to fix the problems. If the Blogger fixes the problems, then he can get orders from Blog Distributor. If he does not fix the problems, he cannot get the orders for Blog Postings from Blog Distributor. The difference between Blog Distributor and the retailer of Blog Postings is that Blog Distributor has real buying power and the retailer does not. Blog Distributor has the ability to send orders for thousands of dollars per month, every month to an individual Blog. The retailer cannot make such large orders. Therefore, the Blog will fix the problems for Blog Distributor but will not fix them for the retailer. The end-result is that the retailer has to spend thousands of hours trying to get Bloggers to fix problems in their Blogs or he can just purchase Blog Postings from Blog Distributor in less than an hour.

Between fixing problems in the Blogs, accurately categorizing them for Sub-Specialty Areas and replacing the concept of every Blog having its own individual pricing with a simple 11-level pricing model, Blog Distributor saves over 6,000 hours of work on an average order for a Blog Posting retailer. That is very valuable to the Blog Posting retailer.

When the Bloggers submits their Blogs to Blog Distributor, they sign an agreement that they will not sell directly to the retailers or end-users that to whom they are connected by Blog Distributor. The agreement states that if they do so, they can be foreclosed from further sales. To ensure their compliance with the agreement, the System utilizes software that monitors all out-going Blog Postings from each Blog who is worked with. This information obtained from this monitoring activity is automatically compared by the System to Blog Postings legitimately purchased through the System. If this comparison determines that a Blog is sending out Blog Postings to any of retailers or end-users to whom he was connected with by the Blog Distributor, and that were not purchased through the System, then the Blogger is contacted and confronted with their actions. If the Blog then refuses to “live up to” the agreement, the System cuts them off from future orders.

In the past, the only way to get links from a website or directory was to contact that website/directory one-at-a-time and negotiate the price of a link from their website/directory to your website. When you are looking for a number of links, this is a very time-consuming project. Now, for the first time, you can purchase a quantity of links using our System. In this respect, it does not matter whether the links are from Blogs or from websites/directories. It just matters that it is easy, for the first time, to purchase quantities of links in a short period of time.

Since, unlike the methods currently employed by other Blog firms, the System is set up to solve major problems in the industry and therefore can deal with a substantially larger volume of sales, the System sends out enough Blog Posting jobs that they comprise a significant source of revenue for Bloggers. If that source of income is threatened to be cut off, it yields significant leverage for the Blog Distributor.

The method of the invention is performed in accordance with the following steps.

Step 1—A Blogger enters the website and fills out a Blogger Signup Form (hereafter, the “Form”) describing in detail their Blog. This includes choosing a Sub-Specialty Area or Areas from a list of possible Sub-Specialty Areas. This list is extensive and, at this time, includes approximately seven thousand (7,000) areas. A Sub-Specialty Area is an area on which the Blog focuses; for example, “Computer”, “Geriatrics”, “Canoeing”, etc.

The process for choosing Sub-Specialty Areas, per keyword, is as follows:

a) In order to choose a Sub-Specialty Area or Areas for his Order, a Reseller must first choose those keywords in his website that he wants to be highly ranked in the search engines.

b) The Reseller scrolls through the Major Specialty Areas listed in the Form on the Blog Distributor website and selects a Major Specialty Area with which a selected keyword would fit. A “Major Specialty Area” comprises a major category of focus for a Blog. Examples of Major Specialty Areas include: “Arts”, “Beauty”, “Computers”, “Disabled”, etc.

c) A “Sub-Specialty Area is a minor category of focus for a Blog and is classified under a Major Specialty Area. Examples of Sub-Specialty Areas that would fit under the Major Specialty Area of “Arts” would include, for example, “Animation”, “Books”, “Dance” and “Movies”. Thus, for example, if a Blog focuses on selling cars in a retail dealership, then one of the Major Specialty Areas for that Blog would be “Shopping/Retail” and the Sub-Specialty Area would be “Cars”.

d) It will be understood by those skilled in the art that it is not uncommon for a keyword to fit under more than one Major Specialty Area. For example, the keyword “tugboat” could fit under the following Major Specialty Areas: “Shopping/Retail”, “Distribution/Wholesale” & “Manufacturing”.

e) It will further be understood by those skilled in the art that a keyword could also fit under multiple Sub-Specialty Areas. For example, the keyword “tomato soup” could fit under the following Sub-Specialty Areas: “Tomatoes” and “Soup”.

f) When a Reseller selects, “clicks on”, the particular Major Specialty Area he wants, all of the Sub-Specialty Areas for that selection will then appear below that Major Specialty Area. The Reseller then scrolls down through the Sub-Specialty Area list until he finds the Sub-Specialty Area that seems to him to most precisely fit his keyword, and then clicks-on or selects that Sub-Specialty Area.

g) In accordance with the method of the invention, the Blogger can choose up to a pre-determined number; for example, five, Sub-Specialty Areas for his Blog. As noted, there currently are approximately 7,000 Sub-Specialty Areas in the System from which to choose.

In completing the Form, the Blogger indicates what price he will accept, with and without a Sub-Specialty Area, and a lower, alternative price, if any, he is willing to accept, again both with and without a Sub-Specialty Area, so to increase the number of jobs he can get. It will be understood that are more jobs available at lower prices. See also, Step 14 hereinafter.

Step 2—if the Blogger lives outside of the USA or Canada or their territories, an error message on first page of the Form informs the Blogger that Bloggers living in these areas are not accepted, and the Blogger will not be allowed to fill out the other pages of the Form. This is done because it has been found that Bloggers living outside of these areas tend to submit Blogs having very poor English, spelling, punctuation and capitalization.

Step 3—The System automatically checks to see if the Blog appears in Google®. If it does not, an error message appears telling the Blogger that only Blogs indexed in Google® are accepted and gives the Blogger directions on how to get their Blog indexed in Google®. The message also invites the Blogger to re-submit their Blog once it is indexed in Google®.

Step 4—The System next automatically checks for “Problem Words” in nine different areas including: pornography/adult, profanity, misspellings, promotes racial intolerance, promotes illegal drug use, hate-oriented language, promotes illegal activity, not all in the English language, promotes illegal activity, and shows the results of this testing process on the first screen that a “Categorizer”; i.e., a staff person who analyzes the Blogs, sees for each Blog.

Step 5—The Categorizer looks at the number of, and the seriousness of, the “Problem Words” that the System has automatically checked in each Blog. The Categorizer then makes a judgment as to whether to: “Decline” or “Ask for Changes” in the Blog. For example, if the Categorizer decides that a particular Problem Word or category of Problem Words is not important in a particular Blog, he can choose to delete that Problem Word or Problem Word Category from the list of Problems included in an electronic mail (“e-mail”) that is automatically generated by the System and sent to the Blogger. For example, an occasional profane word might be considered a minor nuisance, whereas a hundred profane words in a Blog would be considered a major problem for that Blog. This is a matter of judgment by the Categorizer.

Step 6—If there is a problem, the System automatically creates an e-mail that goes to the Blogger informing the Blogger that his/her Blog has either been:

a) declined, in which instance the e-mail includes a list of the “Problem” words included in the Blog, if applicable, or,

b) asks the Blogger to make changes in his/her submitted Blog; e.g., fixing the words included in the list of “Problem” words, and then re-submit the Blog.

Step 7—If a Blogger does make changes and does re-submit the Blog, the Categorizer then re-examines the re-submitted Blog to ensure that the appropriate changes were made. If the changes were made, then the process moves to Step 9. If the requested changes were not appropriately made, the Categorizer sends another e-mail to the Blogger, asking him/her to make the requested changes again. If, after the Blogger is asked to fix the problem(s) a second time and the Blogger re-submits it a second time and the Categorizer checks it a third time and finds that the problem(s) is still not fixed, that Blog Posting job goes back into the System and another Blogger will create it. The System will automatically send an e-mail to the original Blogger telling him that he will not be paid for that Blog Posting.

Step 8—The System automatically checks the number of times that any Sub-Specialty Area(s), that either the Blogger requested or, later in the process that the Categorizer suggested, appear in the Blog. This is done by screen-scraping. This information is displayed on the Blog Analysis page to help the Categorizer decide if there are enough Blog Postings that focus on that Sub-Specialty Area so that the Blog qualifies for that Sub-Specialty Area.

Step 9—For Blogs that have gotten through the prior steps, either because no problems were found, or because the Blogger fixed his/her Blog, as requested, and re-submitted their Blog, the Categorizer now reads through a number of Blog Postings on the Blog to see if there are enough Blog Postings to qualify that Blog for the individual Sub-Specialty Areas the Blogger requested in Step 1.

a) If the Categorizer does not find enough Blogs Postings to qualify the Blog for a particular Blogger-Requested Sub-Specialty Area, the Categorizer clicks on a checkbox that puts that Sub-Specialty Area in a list of Declined Sub-Specialty Areas. It has been found that Bloggers are wrong in their selection of Sub-Specialty Area about 70% of the time.

b) If the Categorizer does find enough Blog Postings to qualify the Blog for a particular Blogger-Requested Sub-Specialty Area, the Categorizer clicks on a checkbox that puts that Sub-Specialty Area in the list of Approved Sub-Specialty Areas.

c) If the Categorizer finds that there are enough Blog Postings to qualify the Blog for a Sub-Specialty Area(s) the Blogger did not request, then the Categorizer clicks on a checkbox that adds that Sub-Specialty Area(s) to a list of Approved Sub-Specialty Areas. Accordingly, a Categorizer can approve a Sub-Specialty Area(s) for a Blog that was not requested by the Blogger.

Step 10—In addition to approving and declining Sub-Specialty Areas for a Blog by reading the Postings on the Blog, the Categorizer may also find other, additional problems in the process. If such problems are found, the Categorizer clicks on a checkbox(s) for the particular type of problem found. There are currently fifteen (15) additional problems that have been identified in addition to the nine (9) Problem Word categories previously noted. Again, as discussed above, the Categorizer can again choose to “Accept”, “Decline” or “Ask for Changes” for the Blog.

Step 11—With respect to these additional problems, the System automatically creates an e-mail that goes to the Blogger. This communication tells the Blogger that their Blog has been:

a) declined (including a list of the “Problem” areas in the Blog);

b) ask that changes to the Blog be made and including a list of the “Problem” areas that need to be fixed; or.

c) accepted (for from zero to five Sub-Specialty Areas).

With respect to Step 11 a), it will be noted that currently, about 50% of the Blogs that are submitted are declined for a variety of reasons.

Step 12—If the Blogger has been asked to make changes, the Blogger can make those changes and then re-submit the Blog. The Categorizer then checks the Blog to ensure that the required changes have been made. If so, the Categorizer approves the Blog and an e-mail goes to the Blogger telling him/her that their Blog has been approved for zero to five Sub-Specialty Areas. If the required changes have not been implemented, an e-mail goes out to the Blogger, telling him/her that he/she still needs to make the necessary changes. The Blogger must make those changes and again re-submit the Blog. If, after the Blogger is asked to fix the problem(s) a second time and the Blogger re-submits it a second time and the Categorizer checks it a third time and finds that the problem(s) is still not fixed, that Blog Posting job goes back into the System and another Blogger will create it. The System will automatically send an e-mail to the original Blogger telling him that he will not be paid for that Blog Posting.

Step 13—Once a Blog has been accepted, it goes into the System, where it can be matched to the needs of Resellers.

By performing the above described steps of the method of the invention, what has been achieved is the production of large quantities of high quality Blog Postings, even though a large percentage of Blogs are poorly and/or unprofessionally written. This results in a significant advantage for Blog Distributor's method.

### Reseller Orders:

Step 14—As part of the method of the present invention, I have created a 2-part pricing model as shown below. First, there are 11 pricing levels based on 11 levels of Popularity. These 11 levels of Popularity are based on the 11 levels of the Google® PageRank™. Additional elements may be added to this pricing model in the future.

Pricing Model

| Blog Distributor's | Price per Blog Post | Price per Blog Post |
|---|---|---|
| Popularity Rating | (no Specialty Area) | (incl. Specialty Area) |
| 11 | $70 | $75 |
| 10 | $65 | $70 |
| 9 | $60 | $65 |
| 8 | $55 | $60 |
| 7 | $50 | $55 |
| 6 | $45 | $50 |
| 5 | $40 | $45 |
| 4 | $35 | $40 |
| 3 | $30 | $35 |
| 2 | $25 | $30 |
| 1 | $20 | $25 |

The pricing shown in the Pricing Model is for example purposes only.

The pricing model indicates pricing without and with a Specialty Area. Some Resellers will care about Specialty Areas and some will not. It is their choice. Blogs having a Specialty Area will typically bear a premium price to Resellers, since this enables End-Users to achieve higher and faster search engine rankings and because we pay a higher price to Blogs that have a Sub-Specialty Area that matches the criteria of the Reseller. This pricing model applies to both third-party Blogs and Internal Blogs.

As discussed in the Background section of this Specification, in most situations, each blog sets its own price per Blog Posting and it is currently very time consuming and expensive for End-Users/Resellers to manually filter through large numbers of Blogs to find the Blogs that are reasonably priced vs. their Popularity and Specialty Area qualities. This makes it extremely difficult to quickly make purchases of quantities of Blog Postings.

As set out above, Blog Distributor's solution is to create an 11-level pricing structure based on the popularity of the Blog and then the Blog buyer has only one more choice, to choose a Sub-Specialty Area or not. This simplified pricing approach saves a Blog Posting buyer thousands of hours in analyzing the pricing of large numbers of Blogs. A normal order can be made using the System in under an hour. Using competitors' current systems, even when a relatively small number of websites need Blog Postings, it is still necessary to manually look through thousands of Blogs in order to find reasonable pricing for Blog Postings.

Step 15—The System is designed so the Reseller does not have to make an order through a salesperson who might not be immediately available when the Reseller wants to place an order. Rather the ordering portion of the System is designed to be extremely simple to use, so the Reseller can place his orders himself on the System's website. Although the background process is quite complex, great care has been taken so that the interface to the Reseller is very simple and intuitive to use.

To make an order on our website, a Reseller fills out an Order Form for each of their websites. Each form includes:

a) The Uniform Resource Locater (URL) of the website;

b) The keywords that the Reseller wants to get highly ranked;

c) The total address (including URL extensions) of the individual page on the website that the Reseller wants to get highly ranked for each individual keyword;

d) A “Product/Service Description”, which is a document of approximately 250 words, that describes the End-User's business. This Product/Service Description is supplied to each Blogger that is going to write Blog Postings for the particular website, to enable them to intelligently write the Blog Posting.

e) How many months for which the Reseller wants the Blog Postings to be ordered.

Step 16—The System automatically matches the Reseller's criteria to the qualifications of the Approved Blogs. Importantly, the method of the invention does not match Blogs to an individual Reseller simply because they are close to that Reseller's criteria. Rather, the matches must be perfect. Otherwise, Resellers will not trust the Blog Distributor to provide the type of Blog Postings that Blog Distributor says it is selling.

Step 17—Since, for most types of businesses, there are not nearly enough third-party Blogs that focus on that particular type of business, in accordance with invention, Internal Blogs are created and used. Internal Blogs are those owned or controlled by a Blog Distributor and can be created in any quantity to match the Sub-Specialty Area requirements of a Reseller. These allow Blog Distributor to supply enough Blog Postings to enable its clients to achieve high search engine rankings. Because of the lack of relevant third-party Blogs, it will be understood that more Blog Postings will be provided (sold) from Internal Blogs than from third-party Blogs. The vast majority of these Internal Blogs will have very low Popularity Ratings (Google® PageRank™). This is because these Blogs will be newly-created to match the criteria of the Reseller, and it takes time for a Blog to achieve a significant PageRank™ popularity rating.

Step 18—The typical Reseller will probably request Blog Postings from Blogs that have a relatively high popularity rating and a Sub-Specialty Area that matches the focus of their client's website.

Step 19—There are not enough Blogs having both a high popularity rating and a focus on each type of business (“Sub-Specialty Area”) for thousands of different types of businesses. In addition, there will be situations where a Reseller wishes to purchase more Blog Postings that have a higher popularity rating than are available. Therefore, when a Reseller chooses these combinations in their order, the System automatically offers them the following alternatives:

a) If there are not enough third-party Blogs with the requested popularity ratings, the System informs the Reseller how many Blogs match his Popularity Rating criteria, how many Blogs have the next lowest Popularity Rating, then the next lowest Popularity Rating, and so forth. This is done until the System shows the Reseller enough Blogs to match his criteria. The Reseller can then select and order the number of Blog Postings the Reseller requires from the selection offered by the System.

b) If there are not enough third-party Blogs that match the Reseller's order for Blogs with particular Sub-Specialty Areas, the System automatically places an order with the number of third-party Blogs that do match the Reseller's Sub-Specialty Area requirements, and then offers the option to the Reseller to fill the balance of his order with Internal Blogs.

c) If there are not enough third-party Blogs that match the Reseller's criteria for both Popularity Rating and Sub-Specialty Area, the System automatically displays to the Reseller the number of Blogs that either match his criteria for Popularity Rating or Specialty Area. The Reseller can then choose to have the Blogs that match his criteria for Popularity Rating or Specialty Area, or a combination of both.

Step 20—Once the Reseller places an initial order, the Reseller can easily modify the order to meet the changing needs of his clients. The System enables the Reseller to add, delete and replace elements of his criteria for each of his clients, and the Reseller can see his orders broken down by individual clients, plus totals for all clients.

Step 21—Since Blog Postings must be purchased for at least a minimum period of time (e.g., six months) to achieve high search engine rankings, and Blog Postings must be purchased by a Reseller indefinitely in order to maintain those high rankings, the System is set up to automatically place new orders for Blog Postings on an ongoing basis. The Reseller can also easily make an order for multiple months of new Blog Postings.

Step 22—When a multi-month order is placed for Blog Postings, for example, 500 Blog Postings, what happens is as follows:

a) in the first month, 500 Blog Postings are ordered from 500 different Blogs;

b) in the second month, 500 Blog Postings are ordered from 500 Blogs which are not the same Blogs that provided the first set of Blog Postings;

c) in the third month, 500 Blog Postings are ordered from 500 Blogs that are either in the first group of Blogs, or from a group of Blogs not previously ordered from for this particular Reseller, or a combination of both groups of Blogs.

d) in the fourth month, the process described in steps a)-c) starts over again.

The reason that we do not use the same group of Blogs for orders in sequential months is that this looks unnatural to the search engines and will result in poorer search engine rankings.

### Third-Party Blog Postings:

Step 23—Once a Reseller places an order for Blog Postings, the System automatically compares his criteria to the qualities offered by pre-Approved Blogs. When there is a match, an e-mail referred to as a “Listing” is automatically sent out to these Blogs, telling them the general subject of the Blog Posting. Normally, these Listings are e-mailed to more Blogs than for which there are orders. The Blogs have 24 hours to reserve the Listing. If not enough Blogs reserve a Listing, then the Listing is provided to additional Blogs that also match the Reseller's criteria.

Step 24—Once a Blog has reserved a Listing, the System automatically e-mails him the details on the Listing including: the particular page on the End-User's website to which the Blog Posting is to be linked, and the keyword or keyword phrase that is the focus of the Blog Posting and the Product/Service Description.

Step 25—The Blogger has 24 hours to write the Blog Posting and link it to the appropriate page on the End-User's website. The Blogger then goes to his section of our website and sends us a message indicating that the Blog Posting is finished.

### Internal Blogs:

Step 26—If the System finds there are not enough external, 3^{rd}-party, Blogs to meet the Sub-Specialty Area criteria of the Reseller, it automatically offers an alternative to the Reseller using Internal Blogs.

Step 27—In preparation for the situation described in Step 26, Blog Distributor will have already purchased URLs, so to be able to respond quickly to an order. From this group of URLs, Blog Distributor will assemble the number of URLs required to satisfy the order. For example, if a Reseller has ordered 100 Blog Postings and there are only 5 third-party Blogs that meet the Reseller's criteria, then the Distributor will pull 95 URLs out of its list of reserved URLs. Doing this enables the Distributor to provide one Blog Posting from each new Blog URL per month to the End-User's website.

### Internal Blog Postings:

Step 28—In accordance with the method of the invention, the System will automatically send out an e-mail to “Internal Writers”. These are writers who will write the Blog Postings which the System then places on the appropriate Internal Blog URLs. The e-mail, which is referred to as an “Internal Listing”, informs the writers that a writing job is available on a particular subject, and they can choose to reserve or not reserve the job of writing one of the Blog Postings.

Step 29—If a particular Internal Writer reserves a particular Internal Listing, a Product/Service Description that was supplied by the Reseller is sent to that Internal Writer, along with the address of the particular website page that the Blog Posting is to be linked to. Using that information, the Internal Writer writes the Blog Posting.

Step 30—The Internal Writer has 24 hours to write the Blog Posting and supply it to the Blog Distributor. The Blogger then goes into his section of our website and sends us a message informing us that the Blog Posting is finished.

Step 31—Once a Blog Posting is completed, whether it is for an Internal Blog or a third-party Blog, it is checked by a “Posting Analyst” (one of our staff members) to see if it matches the criteria established for the posting. If the Blog Posting does not match the criteria, the Posting Analyst sends the Internal Writer an e-mail telling the writer what needs to be fixed on the Blog Posting. The writer revises the Blog Posting, as appropriate, and sends a message back to the Posting Analyst that the Blog Posting has been repaired. The Posting Analyst now reviews the modified Blog Posting and if it is now correct, approves it. The System is programmed to automatically pay the Internal Writer within a stipulated time period after the Blog Posting is approved.

Step 32—Once a Blog Posting is approved, our System automatically places it with other approved Blog Postings on the appropriate Internal Blogs and links them to the End-User's website page.

Step 33—If a Blog Posting is not properly modified, after two analyses and two e-mails to the Internal Writer, the Posting Analyst puts the Listing back into the System and sends the Listing in an e-mail to other Internal Writers, informing them that this Internal Listing is again available. The approval process described above is now repeated with another writer, and the System informs the original Internal Writer that his/her Blog Posting has not been properly corrected and that they will not be paid for that particular Blog Posting.

### Internal Writers:

Step 34—Prior to performing Step 26, the Blog Distributor has to decide which prospective Internal Writers to employ, and this needs to be done efficiently. To test prospective Internal Writers, a website has been created on which a subject; “Cars”, for example, is listed. Each Categorizer Prospect is requested to write about 250 words about the subject. This test is timed to find out how fast the Prospect writes. There is also a time limit as to the maximum amount of time a Prospect can take to do the writing. The System automatically draws the selected subject randomly from a large list of possible subjects for the Prospects to write about, so each writing test will be different. This precaution keeps prospective Internal Writers from copying from each other. Importantly, this test is an indicator as to how good a Prospect is at writing Blogs. The System automatically checks the Prospect's writing for a number (nine) of different problems including: pornography/adult, profanity, misspellings, promotes racial intolerance, promotes illegal drug use, hate-oriented language, promotes illegal activity, not all in the English language, promotes illegal activity and creates a table where the results of all of the Prospects who took the test are compared. This table is only available to the System's managers. A manager will examine the results of this test and based on them decides which Internal Writer Prospects to check further. He also reads the writings from the top-scoring Prospects to see if there are any problems that would cause him to discard any of those Prospects. It will be appreciated by those skilled in the art that this step cannot be automated, but must be done by the manager taking the time to read the various writings. The top Internal Writer Prospects remaining at the end of this process are now interviewed for inclusion into the System's list of Internal Writers.

### Internal Blogs:

Step 35—Search engines do not like to have Blog Postings coming from the same websites (Blogs) every month since this appears unnatural to them. Accordingly, in the situation described in Step 27 above, for the second month's order, the System will select a second group of 100 URLs from the list of reserved URLs and use these to create an additional 100 Internal Blogs. There will be a different group of Internal Writers who will write the required Blog Postings for the second month's order.

Step 36—In the same manner as previously described with respect to Step 27, the System will automatically send out an Internal Listing e-mail to a different group of Internal Writers. Again, the e-mail informs the writers that a writing job is available on a particular subject and they can choose to reserve or not reserve the job of writing one of the Blog Postings.

Step 37—If a particular Internal Writer from this second group reserves a particular Internal Listing, that writer is sent the Product/Service Description supplied by the Reseller. Using this information, the Internal Writer prepares a Blog Posting for the second group of Internal Blogs.

Step 38—In the third and later months of an order for a particular website that needs Internal Blogs, the System may reuse the first set of Internal Blogs, or another new set of Internal Blogs may be created. Switching from one set of Internal Blogs to another set in subsequent months has the advantage of making the process look as “natural” as possible to the search engines.

Step 39—New Internal Blogs will not have any Popularity Rating because they are new, and it takes time to achieve popularity on the Internet. But, they do focus on the Sub-Specialty Area that the Reseller requires. The end-result of this is that the End-User receives the number of Blog Postings that are required from the Blogs focusing on the Sub-Specialty Area that the End-User requires.

### Posting Analysts:

Step 40—For performing Step 31 above, a large number of Posting Analysts are required. To identify and qualify them, a website was created to test Posting Analyst Prospects. Two separate tests are found on the website. Both tests are timed to see how fast a Posting Analyst can perform; and, similar to the single test described in Step 34, there is also a maximum amount of time that a Prospect can take for each test.

The first test includes a number (e.g., 20) of elements where the Posting Analyst Prospect is given a word, for example, “coffee”, and selects one to five Categories that this word would logically fall within. The 20 terms are randomly chosen by the System from a larger number of terms, to prevent Prospects from copying from previous tests. This test indicates how good a Prospect is at categorizing Blogs by Sub-Specialty Area. The System automatically grades the tests and creates a table for management review where all of the Prospects who took the test are compared.

In the second test a word, such as “furniture” is supplied, and the Posting Analyst Prospect is asked to write about 250 words about it. The test word is randomly chosen by the System from a large number of test words so, again, a Prospect cannot copy from previous test takers. This test indicates how good the Prospect is at writing, and is important because it will be necessary for the Posting Analyst to communicate with Bloggers and Internal Writers whose Blog Postings may need to be revised. Similar to what has been previously described; the System automatically checks the Prospect's writing for a number (e.g., nine) of different problems including: pornography/adult, profanity, misspellings, promotes racial intolerance, promotes illegal drug use, hate-oriented language, promotes illegal activity, not all in the English language, promotes illegal activity and creates a management reviewable table where all of the Prospects who took the test are compared.

A System's manager examines the results of the two tests and, based on his analysis decides which Posting Analyst Prospects to further examine. He now reads the writings from the top-scoring Prospects to see if there are any problems that would lead him to discard any of them. Again it will be appreciated by those skilled in the art that this step cannot be automated, but must be done by the manager taking the time to read the various writings. The top Prospects left at the end of this process are now interviewed by management.

### Employees Working From Home:

Step 41—Both the Categorizers and the Posting Analysts work from home and are paid on an hourly basis or salary. This has a number of advantages for these people, including avoiding the expense of commuting, as well as the time spent and the frustrations of commuting, and the stress and frustrations associated with working in an office. In addition, the employees have more free time to spend with their families and on their non-work related activities.

It will be appreciated that having staff who work from home lowers the costs for a Blog Distributor in some ways, but there are also a number of risks. Primary among them is having employees who say they are working when they are not. To avoid this problem, the System automatically monitors each employee by keeping track of the average amount of time it takes for all the employees to do each type of work as compared to the amount of time it takes, on an on-going basis for each individual employee to do each type of work. Thus, if an employee is taking too much time off between jobs, or is averaging too much time to do a particular type of job, System management is alerted. Knowing that their work is being monitored provides an incentive to employees working at home to be industrious.

### Categorizer Training:

Step 42—To ensure that Categorizers can be trained while they are at home, an entirely online system has been created. More than one Categorizer can be trained using the system at a time. Both a Trainer and a Categorizer Trainee(s) login online on the system's website using individual usernames and passwords. Both the Trainer and Categorizer Trainee(s) are on the telephone during a training session, so the Trainer can verbally explain to the trainee how to analyze a Blog while the Trainee is watching the pages that the Trainer is looking at.

The Trainer selects a Blog that is yet to be “Categorized”. Being Categorized means that the Blog is analyzed by both our automated System and manually by a Categorizer. During this Categorization process, the Blog is either:

a) certified, which means accepted for writing Blog Postings for the Blog Distributor;

b) declined, which means not accepted for writing Blog Postings for the Blog

Distributor; or

c) asked to have changes made prior to being accepted for writing Blog

Postings for the Blog Distributor.

As previously discussed, if a Blog is certified, it can be approved for from zero to five Sub-Specialty Areas. That is, the Blog Distributor will match the Blog with a Reseller's orders for up to five Categories of subjects on which both the Blog and Reseller focus.

The Trainer clicks on a “Training” button that shows up on each Blog. Doing this enables the Categorizer Trainee(s) to, in essence, look over the shoulder of the Trainer online while he goes through the process of categorizing a Blog. The Trainee can see exactly what the Trainer sees online, including each minor change to a Blog Analysis page for that particular Blog. This Blog Analysis page is an internal page on the System's website where the Blogs are categorized. The Trainer verbally explains this process to the trainee while he performs his analysis.

Once the Trainer has categorized several Blogs using this process, and believes the Categorizer Trainee(s) is sufficiently trained, the Trainer goes into a “Monitoring” mode which enables him to observe the trainee online while the trainee goes through the process of Categorizing Blogs. This allows the Trainer to see exactly what the trainee sees, online, including each change made by the trainee to the Blog Analysis page for that particular Blog. Once the Trainer is satisfied that the trainee is sufficiently trained, he enables the System to allow the trainee to start Categorizing Blogs on his own.

### Categorizer Prospect Testing:

Step 43—Prior to training Categorizers, they must first be chosen. To do this, a website has been created for testing prospective Categorizers. Two tests are available on this website. Both tests are timed tests to determine how fast a Categorizer Prospect performs the two different types of activities required of him/her, and there is a maximum amount of time a prospect can take for each test.

The first test comprises a series of Categorization “mini-tests” where the prospect is given a word, for example, “lipstick”, and selects from one to five categories in which that word would logically fall. These mini-tests are randomly chosen by the System from a large number of words so a prospect cannot copy from previous tests. This test indicates how good the prospect is at categorizing Blogs by Sub-Specialty Area. The System automatically grades these mini-tests to produce a management viewable table where all of the prospects' test results are compared. An example of a mini-test is shown below.

### Categorization Mini-Test.

### A. Lipstick

### Recreation

### Women

### Work

### Beauty

### Shopping

In the second test, the prospect is supplied a word, for example, “furniture”, and asked to write about 250 words about it. As before, the test word is randomly chosen from a large number of test words to prevent the prospects from copying from previous tests. This test indicates how well the prospect writes, since this is a necessary skill in working with Blogs that have problems that need to be corrected. Again, the System automatically checks the prospect's writing for nine different problems including: pornography/adult, profanity, misspellings, promotes racial intolerance, promotes illegal drug use, hate-oriented language, promotes illegal activity, not all in the English language and promotes illegal activity. Again a table is created comparing the test results for all the prospects who took the test. The table is only reviewable by management. A manager examines the results of the two tests and, based on them, decides on which prospect(s) to examine further. This includes reading the writings from the top-scoring prospect(s) to see if there are any problems that would lead him to not want to employ a prospect. The top prospects remaining at the end of this process are interviewed by management for a position.

### Suggested Order Numbers:

Step 44—To successfully achieve high rankings in search engines, it is necessary to link the correct number of Blog Postings to the End-User's website. Every keyword faces a different level of competition, so every keyword needs a different number of Blog Postings linked to its website. An uncompetitive keyword might need only 5 Blog Postings per month linked to their website to achieve high rankings; whereas, a very competitive keyword might need 100 or more Blog Postings per month linked to their website to achieve high rankings. If an insufficient number of Blog Postings are not linked to a website for a keyword, a high ranking for that keyword will not be achieved. On the contrary, linking too many Blog Posts to a website, is a waste of money. Accordingly, it is important to be able to link the correct number of Blog Posts to a website.

In the process of ordering Blog Postings in the System in accordance with the present invention, a Reseller inputs his keywords into the System, and the System automatically determines and displays the number of Blog Postings that will be needed each month to achieve high rankings in the search engines for each keyword. The Reseller can use that suggested number, or he can choose another number of Blog Postings for each keyword. Unlike prior art systems or methods, the System and method of the present invention automatically determine how many Blog Postings an End-User will need to achieve high rankings. This capability is important to Resellers because they can now quickly order only the necessary number of Blog Postings for their respective clients, knowing that the number they have ordered for each client is the correct number that will achieve high rankings for their End-User clients.

For each keyword, the System works as follows:

a) The Reseller enters a keyword he wants to be highly ranked into the System as part of his order;

b) The System automatically checks to see how competitive this keyword is in the search engines.

c) In the System's database there has been created a table that suggests the correct number of Blog Postings to need to be purchased, based on the level of popularity of the Blog and whether or not the Reseller has chosen as an option Blogs that have a Sub-Specialty Area.

d) The more popular the Blog, the fewer Blog Postings are necessary to achieve high search engine rankings in the websites that it is linked to.

e) Choosing a Blog with a Sub-Specialty Area enables the Reseller to purchase fewer Blog Postings.

f) The level of competitiveness for the keyword entered into the System is compared to ranges of competitiveness entered into the table.

g) The System calculates and automatically recommends the correct number of Blog Postings the Reseller should purchase to achieve high rankings.

h) If the Reseller modifies his Order (for Popularity, Sub-Specialty Area or a different keyword), the System automatically re-analyzes the situation and recommends a new number of Blog Postings to the Reseller.

### Direct Selling Security Measures:

Step 45—Since Bloggers have to know which websites are purchasing their Blog Postings in order to link their Blog Posting to the correct page on the End-User's website, there is a potential problem with Bloggers selling Blog Posting directly to the End-User. This means that both the Blog Distributor and the Reseller could lose income from a Blogger selling directly to an End-User. To prevent this, the method and System of the present invention automatically checks every link that goes out from any Blogger who works with the System. This is monitored, for example, on a monthly basis. If the System determines that a Blogger is selling Blog Postings directly to one of our End-Users or Resellers, then the Blogger is warned that if he continues to sell Blog Postings to that End-User or Reseller, he will never receive any additional work from Blog Distributor. Since the Blog Distributor typically provides a significant income to a Blogger, this is a strong deterrent to third-party Bloggers selling directly to an End-User or Reseller. In addition, since the Blog Distributor owns or controls the Internal Blogs, this is not a problem with respect to them.

The importance of the above described method is that it allows a Reseller to readily select Blog Postings which are particularly suited to a client with whose website they will be used so the website can achieve a high search engine ranking which will translate into more “hits” on the website and ultimately more sales and revenue to the website owner. In particular, these well suited Blog Postings are selected much more quickly and at substantially lower total cost than has otherwise been previously possible.

In view of the above, it will be seen that the several objects and advantages of the present disclosure have been achieved and other advantageous results have been obtained.

1. A method of website ranking promotion using the creation of large numbers of Blog Posting links comprising:
creating a list of Major Specialty Areas each of which categorizes a general business area or activity to which a blog is directed;
identifying Sub-Specialty Areas within each Major Specialty Area so to categorize more specifically a business area or activity to which a Blog is focused;
determining the number of Blog Postings which need to be linked to a website to achieve a high ranking of the website by a search engine, the nature of the website being categorized by a Blog Posting purchaser into at least one Major Specialty Area and at least one Sub-Specialty Area within the Major Specialty Area; and,
providing a requisite number of Blog Postings directed to the Major Specialty Area and Sub-Specialty Area needed to be linked to the website in order to achieve the high ranking, whereby the number and type of Blog Postings provided are provided in a timely and cost efficient manner and allow a purchaser of Blog Postings to quickly purchase a large number of Blog Postings.

2. The method of claim 1 which further enables a purchaser to quickly purchase a large number of links regardless of whether the links include Blog Postings.

3. The method of claim 1 further including;
determining how many blogs written by external bloggers are available to provide the requisite number of Blog Postings; and,
if the number of externally written blogs is insufficient, generating a number of Internal Blogs sufficient to supply the remaining number of Blog Postings required.

4. The method of claim 3 further including:
automatically reviewing external blogs to determine the quality of a blog and identify any problem areas within the blog;
notifying the writer of an external blog of any problem areas identified with respect to the blog and requesting the writer to correct those identified problem areas and resubmit the blog; and,
accepting for use in supplying the requisite number of blogs only those external blogs which are acceptable upon review or in which the writer satisfactorily corrects identified problem areas, thereby to provide high quality Blog Postings to be linked to the website.

5. The method of claim 4 in which the problem areas for which a blog is automatically reviewed includes pornography/adult, profanity, misspellings, not all in the English language, violent language, promotion of racial intolerance, promoting illegal drug use or other illegal activities, and hate-oriented language, so to produce high quality blogs.

6. The method of claim 5 further including manually reviewing each blog and the problem areas for which a blog manually reviewed include: poor English/grammar; the blog not being indexed in Google®; not enough Blog Postings; words missing from sentences; incorrect capitalization; incorrect punctuation; in order for a client to look at the blog, they must set up an account and sign in; the blogger is located outside of the U.S., Canada or their territories; the blog is primarily in an audio or video format; the blog comprises a book in a serial format or a series of articles about a fictional subject; and, the content of the blog is duplicated, at least partially, in another blog or website.

7. The method of claim 6 in which the problem areas for which the blog is manually reviewed further includes the blog, or all of the pages thereof, cannot be accessed; and, the blog merely comprises a bunch of links and the blog is not professional in appearance.

8. The method of claim 1 further including categorizing Blogs according to their Sub-Specialty Area to better enable a purchaser to identify those blogs appropriate for their customer.

9. The method of claim 8 by which the pricing of blogs is partially determined by whether or not a blog is categorized in accordance with a Sub-Specialty Area and partially determined by its popularity level in the Internet.

10. The method of claim 9 in which the price of blogs categorized by a Sub-Specialty Area cost more than blogs not so categorized.

11. The method of claim 8 further including categorizing a blog by a categorizer trained to identify Sub-Specialty Areas in a blog more accurately than they are by the bloggers who create them, so to insure that the Blog Posting link is properly related to the website to which the Blog Posting is linked.

12. The method of claim 11 further including automatically checking a blog for the number of times that a Sub-Specialty Area appears and including both any Sub-Specialty Areas suggested by the categorizer and any Sub-Specialty Areas requested by the blogger.

13. The method of claim 3 in which generating the number of Internal Blogs sufficient to supply the number of Blog Postings required by a blog purchaser includes soliciting Blogs from Bloggers and Internal Writers by broadcasting a Listing specifying the type of Blog Posting required, each Blogger or Internal Writer having the option as to whether or not to supply a Blog Posting in response to the listing.

14. The method of claim 13 further including:
reviewing Blogs Postings supplied by Bloggers and Internal Writers in response to the Listing to determine the quality of a Blog and identify any problem areas within the Blog;
notifying the writer of a Blog Posting of any problem areas identified with respect to the Blog Posting and requesting the writer to correct those identified problem areas and resubmit the Blog; and,
only accepting those Blog Postings which are acceptable upon review or in which the writer satisfactorily corrects identified problem areas, thereby providing high quality Blog Postings to be linked to the website.

15. The method of claim 1 in which lists of Major Specialty Areas and Sub-Specialty Areas are prepared portions of which are encrypted to prevent their being stolen and portions of which can be viewed with only the visible portions of the lists of Major Specialty Area and Sub-Specialty Areas being provided to Bloggers, employees and prospective purchasers.

16. The method of claim 1 further including identifying and training employees including Categorizers who review external Blogs and Posting Analysts who review Blog Postings from external and Internal Blogs for acceptability, the training allowing the employees to work remotely.

17. The method of claim 17 further including automatically monitoring employees working remotely to ensure their consistent productivity.

18. The method of claim 3 further including monitoring Blog Postings from a Blog that is working with Blog Distributor, comparing the Blog Postings with Blog Postings purchased from the Blog Distributor and notifying the blog if the comparison determines that the blog is sending out Blog Postings to retailers or end-users with whom he was connected to by the Blog Distributor.

19. The method of claim 1 further including breaking down the Major Specialty Area or Sub-Specialty Area into at least the following demographic sections; man/woman; age group; shopping/retail; distribution/wholesale; manufacturing; end-user; products/equipment, products/repair; upkeep inspection; maintenance of products/equipment; building/locations; and repair, upkeep inspection, and maintenance of building/locations, thereby to produce a categorization of data in which the context enables a searcher to quickly find the information for which they are looking.

20. A method of categorizing business related data so to enable a researcher to quickly find a pertinent piece of information for which they are searching, comprising:
creating a list of Major Specialty Areas each of which categorizes a general business area or activity;
identifying Sub-Specialty Areas within each Major Specialty Area so to categorize more specifically a business area or activity; and,
breaking down each Major Specialty Area or Sub-Specialty Area into at least the following demographic sections; man/woman; age group; shopping/retail; distribution/wholesale; manufacturing; end-user; products/equipment, products/repair; upkeep inspection; maintenance of products/equipment; building/locations; and repair, upkeep inspection, and maintenance of building/locations, thereby to produce a categorization of data in which the context enables a searcher to quickly find the information for which they are looking.
